(19) United States
(12) Patent Application Publication
(10) Pub. No.: US 2015/0031229 A1
(43) Pub. Date: Jan. 29, 2015

(54) Electrical contact element, connector housing and plug connector

(71) Applicant: ROBERT BOSCH GMBH, Stuttgart (DE)

(72) Inventor: Martin Saur, Salach (DE)

(73) Assignee: Robert Bosch GmbH, Stuttgart (DE)

(21) Appl. No.: 14/384,645

(22) PCT Filed: Jan. 30, 2013
(86) PCT No.: PCT/EP2013/051783

§ 371 Date: Sep. 11, 2014

(30) Foreign Application Priority Data
Mar. 14, 2012 (DE) 10 2012 203 990.2

(51) Int. Cl. H01R 13/627

(52) U.S. Cl. CPC H01R 13/627
USPC 439/350

(57) ABSTRACT

An electrical contact element for a connector housing having a contact chamber for receiving the electrical contact element includes: a first fastening portion for electroconductively fastening an electrically conductive conductor of an electrical line; and a contact portion adapted to be intermated with a corresponding mating contact element in the plug-in direction, the contact portion and the first fastening portion being electroconductively interconnected. The first fastening portion and the contact portion are spaced apart from one another essentially transversely to the plug-in direction to allow the mating contact element to be guided through the contact portion past the first fastening portion when the conductor is permanently connected to the fastening portion.

### BACKGROUND OF THE INVENTION

1. Field of the Invention

The present invention relates to an electrical contact element, connector housing, and a plug connector.

2. Description of the Related Art

Electrical plug connectors for producing an electrical plug connection are known from the related art. In the automotive industry, in particular, plug connectors having a plurality of poles for connecting actuators, control units, display instruments, as well as sensors, are used in various forms. The electrical plug connectors are typically connected at the ends of cable trees. The electrical plug connector essentially includes a connector housing having at least one contact chamber; each contact chamber being able to have an electrical contact element mounted therein. Electrical plug connectors are generally designed to be slid along a plug-in direction onto a mating connector having corresponding mating contact elements; the electrical lines extending counter to the plug-in direction. The electrical lines are generally connected to the electrical contact elements in a way that allows the line insulation, including the inwardly disposed conductor, to be enclosed by a fastening portion that is securely affixed to the contact element and acts as strain relief. A second fastening portion of the contact element connects the electrically conductive conductor of the electrical line electroconductively to a contact portion that is electroconductively connectable to a mating contact element. The configuration whereby the electrical lines are routed counter to the insertion direction out of the connector housing has proven to be especially effective since these types of connector housings can be manufactured very inexpensively. In addition, the lines outgoing from the connector housing may be used in certain configurations in the case that a connector—mating connector combination is separated by exerting tensile force on the lines.

In conjunction with the configuration described above and increasing miniaturization, even in automobile manufacturing, the length of such plug connectors can also be detrimental in certain application cases.

### BRIEF SUMMARY OF THE INVENTION

Therefore, there is a need to provide a plug connector whose design is more compact than those of the related art.

In accordance with a first exemplary embodiment of the present invention, an electrical contact element for a single- or multi-pole connector housing is provided with at least one contact chamber for receiving the at least one electrical contact element. The electrical contact element features a first fastening portion for electroconductively fastening an electrically conductive conductor of an electrical line. The electrical contact element has a contact portion, the contact portion being adapted to be intermated with a corresponding mating contact element in the plug-in direction. The contact portion and the first fastening portion are electroconductively interconnected. The first fastening portion and the contact portion are spaced apart from one another essentially transversely to the plug-in direction in a way that allows the mating contact element to be guided through the contact portion past the first fastening portion when the conductor is connected to the fastening portion.

This makes it possible to reduce the overall height of the electrical contact element in comparison to the related art, without having to thereby modify the contact spacing. Contact spacing is understood to be the distance from a first central axis of a first electrical contact element to a second central axis of a second contact element that is adjacent to the first contact element. Reducing the overall height of the contact element also makes it possible to reduce that of the connector housing in comparison to related art embodiments. Thus, the electrical contact element according to the present invention makes possible a more compact design for the plug connector. A crimping method is generally used to connect the electrical conductor, as well as the insulation sheathing thereof, to the contact element. Prior to implementation of the crimping method, the first fastening portion for receiving the conductor, and the second fastening portion for receiving an insulation sheathing of the conductor and, as needed, a seal, are typically formed in a U-shape. During crimping, a tool may grip around the U-shaped fastening portion and compress it into an essentially C-shaped clip that permanently connects the sheathing, respectively the conductor, to the electrical contact element. In the case of the contact element provided here, the conductor may essentially extend both along the plug-in direction, as well as at an angle, in particular at a right angle, to the plug-in direction. Independently thereof, a more compact plug connector design advantageously permits a realization whereby the contact portion may either extend linearly or at an angle relative to the line. In particular, when the electrical conductor and the contact element essentially extend along the plug-in direction, it is possible in the case of electrical contact element presented here, for the contact portion to be displaced toward the first fastening portion in a way that allows the crimping tool to grip around the first fastening portion, thereby making the crimping method feasible. The design of the contact portion may allow the mating contact element to be guided past the first fastening portion when the conductor is connected to the first fastening portion. In this case, the mating contact element may at least partially overlap the first fastening portion when the electrical contact element according to the present invention is displaced relative to the mating contact element into the predetermined position thereof. Also, the contact portion may be configured relative to the first fastening portion in a way that allows the mating contact element to contact the first fastening portion.

In accordance with another exemplary embodiment of the present invention, the electrical contact element features a second fastening portion for fastening an electrically insulating sheathing of the electrical line. The line extends essentially along the plug-in direction. The second fastening portion may be bounded by a square-shaped, hollow-cylindrical lateral surface that essentially extends along the plug-in direction when the sheathing is permanently joined to the second fastening portion. The lateral surface is not overlapped by the contact portion when the conductor is connected to the first fastening portion.

In this case, the square-shaped, hollow-cylindrical lateral surface extends along a central axis, this middle axis also being able to be the middle axis of the electrical line, including the electrical contact element connected thereto. The lateral surface may contact the second fastening portion. The contact portion may likewise contact the lateral surface or be spaced apart therefrom in the direction of the central axis. This makes it possible for an electrical contact element having such a design to be displaced in the plug-in direction into a connector housing, without necessitating a two-part design for the connector housing to accommodate any excess length beyond the second fastening portion. Thus, the contact chamber configured in the connector housing may have an inner wall that faces the contact element and that essentially forms the square-shaped, hollow-cylindrical lateral surface, at least in one partial region.

Another exemplary embodiment of the present invention provides that the electrical contact element feature a second fastening portion for fastening an electrically insulating sheathing of the electrical line. The line extends essentially along the plug-in direction. When the sheathing is permanently joined to the second fastening portion, the second fastening portion may be bounded by a lateral surface that essentially extends along the plug-in direction and, in cross section, is substantially circular and hollow-cylindrical. The contact portion does not project beyond the lateral surface when the conductor is connected to the first fastening portion.

This inventive design differs from the exemplary embodiment described in the next-to-last paragraph merely in that the square cross section is replaced by a circular one. In terms of surface area, the circular cross section is generally smaller than the square one, it being possible for the side faces of the square lateral surface to be tangential to the circular lateral surface. Accordingly, the contact chamber of the connector housing may likewise advantageously have an essentially circular cross section in at least one partial region. This makes it possible for electrical contact elements, which feature a sealing element that is generally circular in cross section and that, together with the electrically insulating sheathing of the electrical line of the second fastening portion, is typically inseparably connected to the electrical contact element, to be introduced into the contact chamber in a way that prevents the ingress of moisture and dirt into the electrical contact element.

Another exemplary embodiment of the present invention provides that the first fastening portion and the second fastening portion be configured in a way that allows the conductor and the sheathing to essentially extend along a common first central axis when they are secured to the respective fastening portion thereof.

By employing such an embodiment, the crimping process does not displace the electrical conductor relative to the sheathing thereof. Thus, the press forces exerted on the electrical conductor prevent any additional bending forces caused by a potential deflection. This may have an advantageous effect on the connection of the electrical contact element to the electrical line, making it possible to prolong the service life of the electrical plug connector.

Another exemplary embodiment of the present invention provides that the contact portion extend along a second central axis; the first central axis and the second central axis extending mutually in parallel.

This advantageously allows the connector to intermate with a mating connector in the plug-in direction, without generating a relative movement transversely to the plug-in direction, as would be the case if the first central axis and the second central axis were to subtend an angle. This makes it possible to prevent damage to the mating contact element, respectively to the contact element caused by bending forces induced by the intermating of the mating plug connection and the plug connection.

Another exemplary embodiment of the present invention provides that a contact element member from the first fastening portion, the second fastening portion, and the contact portion be formed in one piece.

This allows a stamped bent part design of the contact element member, thereby making possible a cost-effective manufacturing. An embodiment, whereby the contact element member may be fabricated out of a material having good electroconductive properties, such as brass or bronze, ensures, in particular, an efficient conductivity between the first fastening portion and the contact portion. In particular, the contact portion may be configured to rest resiliently against the mating contact element, making it possible to thereby compensate for manufacturing tolerances of the contact element and/or of the mating contact element.

Another exemplary embodiment of the present invention provides that the contact portion for receiving a mating contact element be designed to have an essentially rectangular cross section.

This also encompasses square cross sections here. Mating contact elements of this kind are also known as blade contact elements or pin contact elements. It is self-evident that the contact portion may also have a different design in order to receive corresponding mating contact elements.

Another exemplary embodiment of the present invention provides that the contact portion be enclosed by a cage element having a locking lance. The locking lance is displaceable from a first position into a second position and vice versa. In the first position, the locking lance projects obliquely outwardly and is lockingly engageable with a contact chamber of a connector housing. Transversely to the plug-in direction and facing away from the first fastening portion, the contact portion is essentially bounded by a plane. Neither the contact element nor the locking lance projects beyond the plane.

The length of the electrical contact element is determined by the plane and an upper end of the contact element disposed in opposition thereto. The cage element, which typically constitutes a separate component and is generally made of steel, encloses the contact portion in such a way that the length between the plane and the upper end is not changed. In this connection, the cage element may reinforce the resilient properties of the contact portion.

Another exemplary embodiment of the present invention provides that a connector housing having a contact chamber of electrically insulating material be provided for receiving an electrical contact element, as previously described. The electrical contact element is introducible into the contact chamber along a third central axis. An electrical mating contact element is introducible into the contact chamber along a fourth central axis. The third central axis and the first central axis of the electrical contact element are essentially the same. The fourth central axis and the second central axis of the electrical contact element are essentially the same.

On the one hand, this makes it possible to ensure that, for the prefabrication process, the electrical contact element, together with the electrical line connected thereto, be readily introducible into the connector housing; the locking lance interlocking with the contact chamber and, in this manner, being able to prevent an unwanted removal of the contact element from the connector housing. On the other hand, by employing such an embodiment, it is possible to ensure that the connector housing equipped with the electrical contact element and a mating connector housing equipped with a mating contact element be readily intermatable.

Another exemplary embodiment of the present invention provides that a plug connector have a connector housing, as previously described, and an electrical contact element, as previously described.

It is noted that ideas pertaining to the present invention are described herein in the context of an electrical contact element, a connector housing, as well as a plug connector. It is evident to one skilled in the art that each of the described features may be combined with one another in different ways in order to thereby arrive at other embodiments of the present invention as well.

### BRIEF DESCRIPTION OF THE DRAWINGS

FIG. 1 shows a longitudinal cross section of an electrical plug connector known from the related art having an electrical contact element configured in a connector housing.

FIG. 2 shows a longitudinal cross section of an electrical plug connector according to the present invention having an inventive electrical contact element configured in a respective connector housing.

FIG. 3 shows a cross section of an electrical plug connector known from FIG. 2.

### DETAILED DESCRIPTION OF THE INVENTION

Specific embodiments of the present invention are described in the following with reference to the enclosed figures. The figures are merely shown schematically and are not true-to-scale.

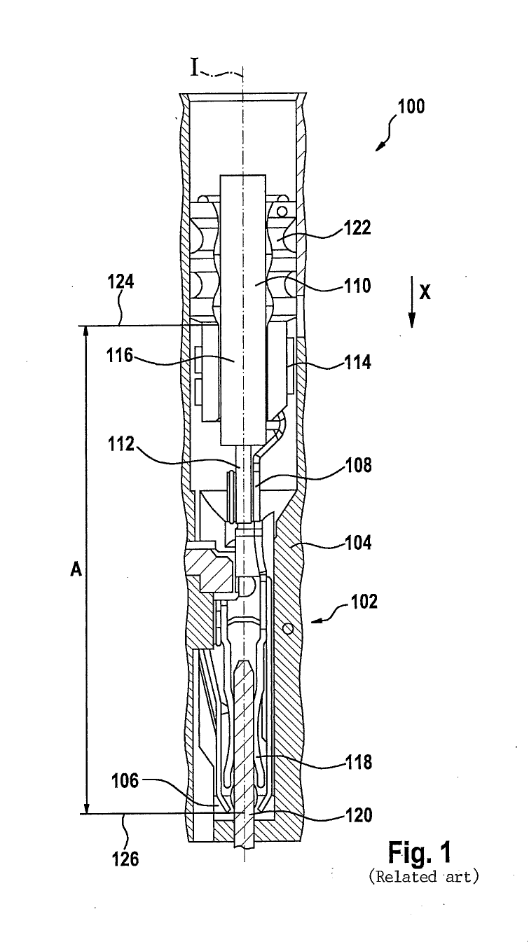

FIG. 1 shows an electrical plug connector 100 in accordance with the related art. Electrical plug connector 100 is essentially composed of an electrical contact element 102 and a connector housing 104 having a contact chamber 106.

Electrical contact element 102 is connected to an electrical line 110. Electrical contact element 102 is locked engagingly in contact chamber 106. Electrical line 110 has an electrically conductive conductor 112 that is electroconductively connected via a first fastening portion 108 to electrical contact element 102. In addition, electrical line 110 has an insulation sheathing 116 that is connected via a second fastening portion 114 to electrical contact element 102. Moreover, disposed contiguously to first fastening portion 108 in a plug-in direction X is a contact portion 118 that electroconductively contacts a mating contact element 120. A sealing element 122 having an essentially circular cross section is threaded onto electrical line 110, sealing element 112 being inseparably connected to second fastening portion 114. Contact chamber 106 is sealed in plug-in direction X by sealing element 122 in a way that seals electrical contact element 102 against the ingress of moisture or dirt in conjunction with an electrical mating connector (not shown here). It is readily apparent in the illustration shown here that contact portion 118, in conjunction with mating contact element 120, first fastening portion 108, respectively electrically conductive conductor 112 connected to first fastening portion 108, as well as second fastening portion 114, respectively insulation sheathing 116 permanently joined to second fastening portion 114, extend along a common central axis 1. Thus, a first length A of electrical contact element 102 known from the related art is obtained between a lower edge 126 of contact portion 118 and an upper edge 124 of contact element 102.

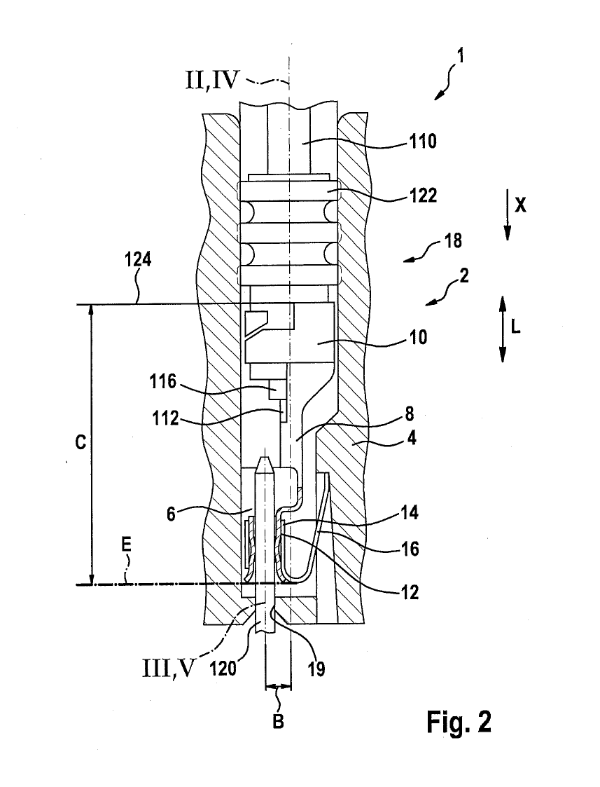

FIG. 2 shows an electrical plug connector 1 according to the present invention having an inventive electrical contact element 2 that is fixed in position in a contact chamber 6 of a connector housing 4. As is already known from FIG. 1, from electrical line 110, electrically conductive conductor 112 is permanently connected to a first fastening portion 8, and insulation sheathing 116, in conjunction with sealing element 122, is permanently connected to a second fastening portion 10. In this case, first fastening portion 8, respectively electrically conductive conductor 112, and second fastening portion 10, respectively insulation sheathing 116, together with sealing element 122, extend along a common first central axis II. A contact portion 12 is electroconductively connected to second fastening portion 10. Line 110 extends along first central axis II, respectively counter to plug-in direction X, away from contact element 2. First fastening portion 8 and contact portion 12 are spaced apart from one another transversely to plug-in direction X of electrical contact element 2 in a way that allows mating contact element 120 to be guided through contact portion 12 past first fastening portion 8. In this case, plug-in direction X refers both to the insertion of contact element 2 into connector housing 4, as well as to the mating of contact element 2 and of mating contact element 120. Here, contact portion 12, in conjunction with mating contact element 120, extends along a second central axis III. First central axis II and second central axis III extend essentially mutually in parallel and are spaced apart by a predetermined distance B. Electrical contact element 2 having electrical line 110 is introduced along plug-in direction X into connector housing 4, respectively contact chamber 6. In this case, contact chamber 6 extends along a third central axis IV; in the assembled state, third central axis IV and first central axis II being the same. Extending along a fourth central axis V in connector housing 4 by distance B is an opening 19 through which mating contact element 120 is introduced into contact chamber 6 counter to plug-in direction X. Here as well, fourth central axis V is the same as second central axis III. In addition, relative to a direction of longitudinal extent L of contact element 2, contact portion 12 is spaced apart from first fastening portion 8 in a way that allows a crimping tool to grip around first fastening portion 8 to fasten conductor 112 to electrical contact element 2, without being hindered by contact portion 12. In accordance with this requirement, contact portion 12 may also be displaced closer to first fastening portion 8 than is shown in FIG. 2. First fastening portion 8, second fastening portion 10, and contact portion 12 form a contact element member 18 that is made in one piece of readily conductive material, namely brass. Contact portion 12 has a resilient design, so that it is securely electroconductively connected to mating contact element 120. Contact portion 12 is surrounded by a cage element 14 that is typically fabricated of another material, namely steel, and has a locking lance 16; locking lance 16 being releasably locked to connector housing 104. Contact portion 12 is bounded by a plane E at a side facing away from first fastening portion 8. Neither cage element 14 nor locking lance 16 projects beyond this plane E. Electrical contact element 2 has a second length C that is derived between plane E and upper edge 124 of contact element 2. In comparison to the representation of FIG. 1, it is apparent that second length C is shorter than first length A. If, for example, at a contact spacing of 4 mm, dimension A is 16 mm, dimension C is 10.8 mm. Thus, compared to first length A of contact element 102, second length C of contact element 2 according to the present invention is reduced by about one third. This makes it possible for connector housing 4 to have a shorter configuration than connector housing 104. Thus, a more compact embodiment of electrical connector housing 1 is realized in comparison to electrical plug connector 100 from the related art.

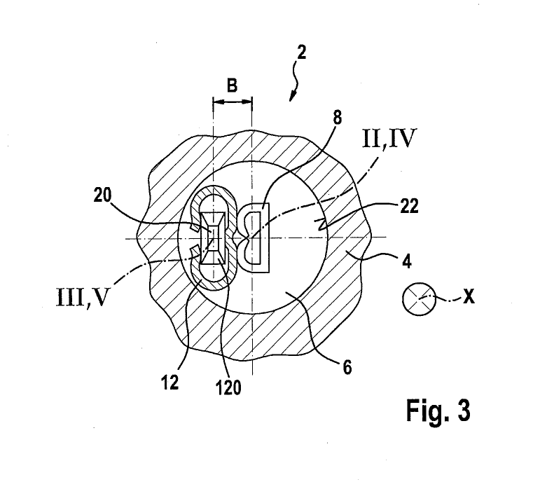

As is more readily apparent in FIG. 3, contact chamber 6 has an essentially circular, hollow-cylindrical lateral surface 22 that essentially extends along plug-in direction X and, at the same time, also forms an inner wall of contact chamber 6. For reasons of clarity, FIG. 3 merely shows first fastening portion 8 without the electrical line, as well as contact portion 12, along with mating contact element 120 having an essentially rectangular cross section 20. It is clearly discernible that contact portion 12 is located within lateral surface 22 of contact chamber 6. Such an embodiment makes it possible for a contact spacing, as is customary, particularly in the case of multipole plug connectors 1, to be unchanged relative to the related art.

1-10. (canceled)

11. An electrical contact element for a connector housing having at least one contact chamber for receiving the electrical contact element, the electrical contact element comprising:
a first fastening portion electroconductively fastening an electrically conductive conductor of an electrical line; and
a contact portion configured to be intermated with a corresponding mating contact element in a plug-in direction; wherein:
the contact portion and the first fastening portion are electroconductively interconnected; and
the first fastening portion and the contact portion are spaced apart from one another essentially transversely to the plug-in direction to enable the mating contact element to be guided through the contact portion past the first fastening portion when the conductor is permanently connected to the fastening portion.

12. The electrical contact element as recited in claim 11, further comprising:
a second fastening portion for fastening an electrically insulating sheathing of the electrical line, wherein the electrical line extends essentially along the plug-in direction;
wherein the second fastening portion, when the electrically insulating sheathing is permanently joined to the second fastening portion, is bounded by a lateral surface which essentially extends along the plug-in direction and is essentially square-shaped and hollow-cylindrical in cross section, and wherein the contact portion does not project beyond the lateral surface when the conductor is connected to the first fastening portion.

13. The electrical contact element as recited in claim 11, further comprising:
a second fastening portion for fastening an electrically insulating sheathing of the electrical line, wherein the electrical line extends essentially along the plug-in direction;
wherein the second fastening portion, when the electrically insulating sheathing is permanently joined to the second fastening portion, is bounded by a lateral surface which essentially extends along the plug-in direction and is essentially circular and hollow-cylindrical in cross section, and wherein the contact portion does not project beyond the lateral surface when the conductor is connected to the first fastening portion.

14. The electrical contact element as recited in claim 13, wherein the first fastening portion and the second fastening portion are configured to allow the conductor and the electrically insulating sheathing to essentially extend along a common first central axis when the conductor and the electrically insulating sheathing are secured to the respective fastening portions.

15. The electrical contact element as recited in claim 14, wherein the contact portion extends along a second central axis, and wherein the first central axis and the second central axis essentially extend mutually in parallel.

16. The electrical contact element as recited in claim 13, wherein the first fastening portion, the second fastening portion, and the contact portion together form a one-piece contact element member.

17. The electrical contact element as recited in claim 12, wherein the contact portion for receiving the mating contact element has an essentially rectangular cross section.

18. The electrical contact element as recited in claim 11, wherein:
the contact portion is enclosed by a cage element having a locking lance which is displaceable between a first position and a second position;
in the first position, the locking lance projects obliquely outwardly and lockingly engages with a contact chamber of a connector housing; and
transversely to the plug-in direction and facing away from the first fastening portion, the contact portion is essentially bounded by a plane, and neither the cage element nor the locking lance projects beyond the plane.

19. The electrical contact element as recited in claim 11, wherein:
the electrical contact element is introduced into the contact chamber along a third central axis;
the mating contact element is introduced into the contact chamber along a fourth central axis;
the third central axis and the first central axis of the electrical contact element are essentially the same; and
the fourth central axis and the second central axis of the electrical contact element are essentially the same.
